(19) United States
(12) Patent Application Publication
(10) Pub. No.: US 2012/0271713 A1
(43) Pub. Date: Oct. 25, 2012

(54) METHOD OF USING GPS AND/OR VEHICLE SENSOR DATA FOR DETECTING USER INTERESTS AND BENEFITS, AND FOR ADVERTISEMENT TARGETING

(75) Inventors: Dale Nussel, Mahomet, IL (US); Jonathan Kilroy, Champaign, IL (US); Allie K. Watfa, Urbana, IL (US); Anupam Seth, Urbana, IL (US)

(73) Assignee: Yahoo! Inc., Sunnyvale, CA (US)

(21) Appl. No.: 13/092,763

(22) Filed: Apr. 22, 2011

(51) Int. Cl. G06Q 30/00

(52) U.S. Cl. 705/14.53

(57) ABSTRACT

The present invention provides techniques for use in providing advertisers and other entities with information relating to target audiences. Techniques are provided in which real-time travel information may be obtained from users' GPS devices to determine one or more potential interests of users. The potential interests may then be used to generate or select advertisements that may be relevant to the users. The advertisements may be transmitted to the GPS devices for presentation on the GPS devices.

### BACKGROUND

Advertisers (including proxies, agents, or other entities acting on behalf of or in the interest of advertisers) compete for user attention. By effective referencing and use of topics of interest in their advertising, advertisers grab attention, build rapport with audiences, and increase brand cachet. For example, in maintaining distinctiveness and relevance, advertisers benefit from, among other things, knowledge of interests and trending interests of their target audiences.

One particular target audience of interest to advertisers is users who are traveling in vehicles. There is a need for techniques for use in, among other things, providing advertisers and other entities with information relating to users who are traveling.

### SUMMARY

Exemplary embodiments of the invention provide methods and systems for obtaining real-time travel information from users' GPS devices to determine potential interests of users. The potential interests may then be used to select advertisements and present the advertisements to users on the GPS devices. The GPS devices may include GPS-enabled mobile devices such as cell phones, PDAs, tablets, mobile navigation units, etc. In addition, GPS devices may also include in-vehicle GPS enabled navigation systems.

The real-time travel information may include the user's travel route, real-time direction of travel, real-time weather information along the user's travel route, real-time traffic information along the user's travel route, etc. In addition, the real-time travel information may also include user profile information. The user profile information may provide additional information relating to the user's interests. In one embodiment, the user profile information may be an online profile which may be retrieved by obtaining the user's permission (e.g., by asking a user to enter a username and password). In one embodiment, at least part of the real-time travel information may be obtained from third-party services (e.g., real-time traffic, weather, etc.). Alternatively, or in addition, at least part of the real-time travel information may be received directly from the user's GPS device (e.g., origin location, destination location, direction of travel, etc.).

In exemplary embodiments, one or more potential interests of the user may be determined based at least in part on the travel information. For example, if real-time traffic information indicates that there is a traffic jam a few miles ahead along the user's travel route, the system may determine that the user may prefer to take an early exit and relax over a cup of coffee instead of being stuck in traffic. In another example, real-time travel information may indicate that a storm is approaching the user's destination. Based on this information, the system may determine that the user may like to purchase an umbrella prior to arriving at the destination.

In some embodiments, one or more potential interests may be determined based at least in part on real-time vehicle information obtained from one or more sensors in the vehicle. Real-time vehicle information may include, for example, oil level, gasoline level, tire pressure, coolant level, windshield wiper fluid level, etc. The one or more sensors may transmit the vehicle information to the GPS device. The vehicle information may then be obtained by one or more server and/or advertiser computers from the GPS device via the Internet.

In some embodiments, an advertisement may be selected based at least in part on at least one of the one or more potential interests. In the examples discussed above, an advertisement for a nearby coffee shop, or an advertisement for a store that sells umbrellas may be selected.

In some embodiments, the selected advertisement is transmitted to the GPS device of the user for presentation on the GPS device. The advertisement may include textual, graphical, audio and/or video data, and may be displayed or played directly on the GPS device.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a flow diagram illustrating a method according to one embodiment of the invention; and

FIG. 5 is a block diagram illustrating one embodiment of the invention.

While the invention is described with reference to the above drawings, the drawings are intended to be illustrative, and the invention contemplates other embodiments within the spirit of the invention.

### DETAILED DESCRIPTION

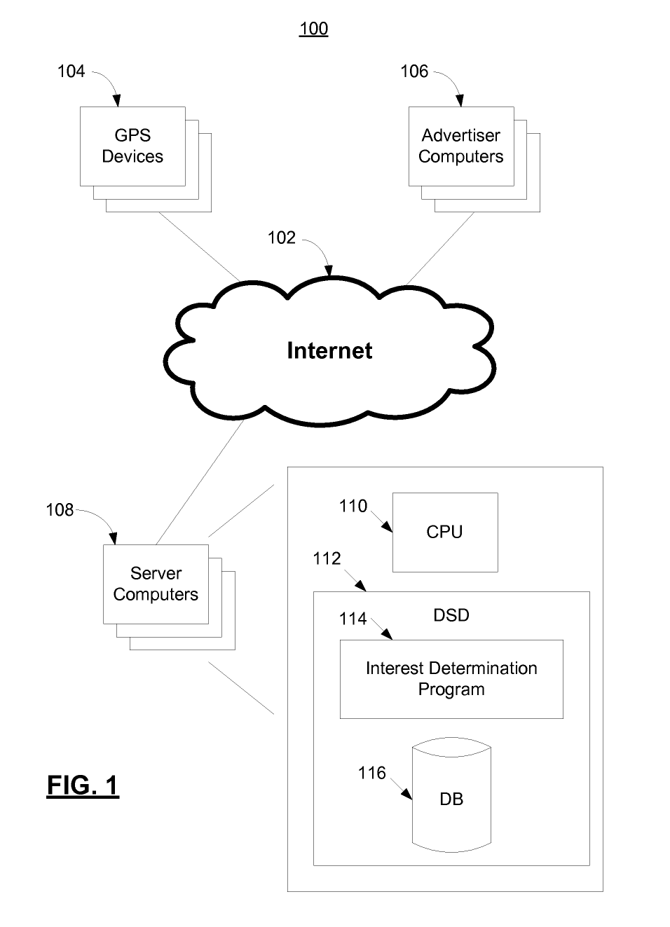

FIG. 1 is a distributed computer system 100 according to one embodiment of the invention. The system 100 includes GPS devices 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which GPS devices 104 may be GPS-enabled portable, handheld or mobile devices such as cell phones, PDAs, tablets, mobile navigation units, etc. In addition, GPS devices 104 may also include in-vehicle GPS enabled navigation systems.

Each of the one or more computers 106 and 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, graphical advertisements, rich advertisements, video advertisements, coupons, group discounts, etc.

As depicted, each of the server computers 108 includes one or more CPUs 110 and a data storage device 112. The data storage device 112 includes a database 116 and an Interest Determination Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

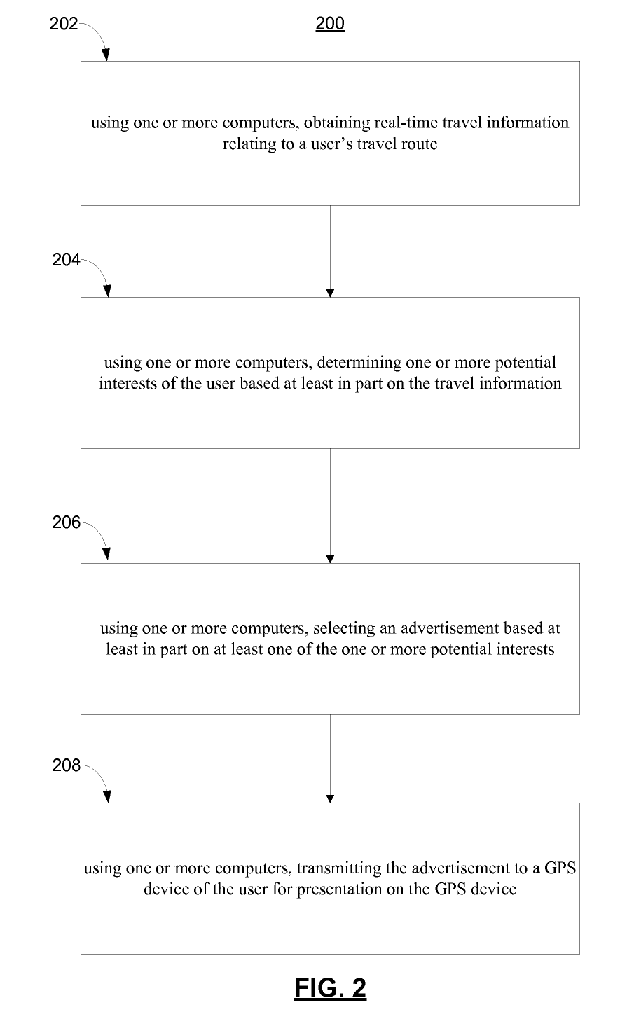

FIG. 2 is a flow diagram illustrating a method 200 according to one embodiment of the invention. At step 202, using one or more computers, real-time travel information relating to a user's travel route is obtained. The real-time travel information may include the user's travel route, real-time direction of travel, real-time weather information along the user's travel route, real-time traffic information along the user's travel route, etc. In addition, the real-time travel information may also include user profile information. The user profile information may provide additional information relating to the user's interests. In one embodiment, the user profile information may be an online profile which may be retrieved by obtaining the user's permission (e.g., by asking a user to enter a username and password). In one embodiment, at least part of the real-time travel information may be obtained from third-party services (e.g., real-time traffic, weather, etc.). Alternatively, or in addition, at least part of the real-time travel information may be received directly from the user's GPS device (e.g., origin location, destination location, direction of travel, etc.).

At step 204, using one or more computers, one or more potential interests of the user are determined based at least in part on the travel information. For example, if real-time traffic information indicates that there is a traffic jam a few miles ahead along the user's travel route, the system may determine that the user may prefer to take an early exit and relax over a cup of coffee instead of being stuck in traffic. In another example, real-time travel information may indicate that a storm is approaching the user's destination. Based on this information, the system may determine that the user may like to purchase an umbrella prior to arriving at the destination.

At step 206, using one or more computers, an advertisement is selected based at least in part on at least one of the one or more potential interests. In the examples previously discussed, an advertisement for a nearby coffee shop, or an advertisement for a store that sells umbrellas may be selected.

At step 208, using one or more computers, the advertisement is transmitted to the GPS device of the user for presentation on the GPS device. The advertisement may include textual, graphical, audio and/or video data, and may be displayed or played directly on the GPS device.

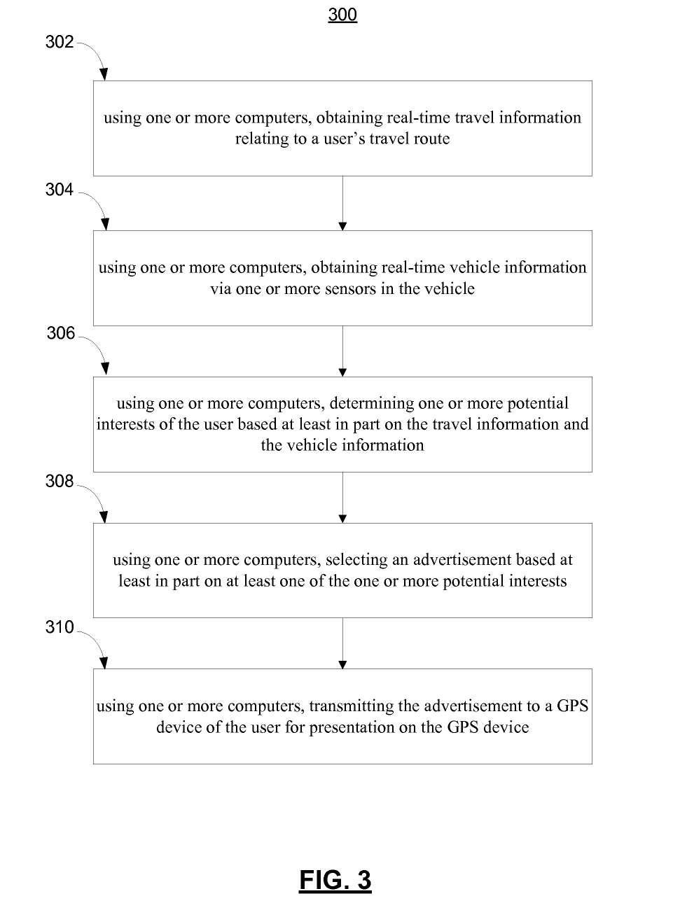

FIG. 3 is a flow diagram illustrating a method 300 according to one embodiment of the invention. At step 302, using one or more computers, real-time travel information relating to a user's travel route is obtained.

At step 304, using one or more computers, real-time vehicle information is obtained via one or more sensors in the vehicle. In one embodiment, real-time vehicle information may include, for example, oil level, gasoline level, tire pressure, coolant level, windshield wiper fluid level, etc. The one or more sensors may transmit the vehicle information to the GPS device. The vehicle information may then be obtained by one or more server and/or advertiser computers from the GPS device via the Internet.

At step 306, using one or more computers, one or more potential interests of the user are determined based at least in part on the travel information and the vehicle information. In some embodiments, interests may be determined utilizing information obtained from or relating to one or more social networking Web sites or companies.

At step 308, using one or more computers, an advertisement is selected based at least in part on at least one of the one or more potential interests. For example, if the car is low on gas, an advertisement for a gas station at the next exit may be selected for presentation on the GPS device.

At step 310, using one or more computers, transmitting the advertisement to a GPS device of the user for presentation on the GPS device.

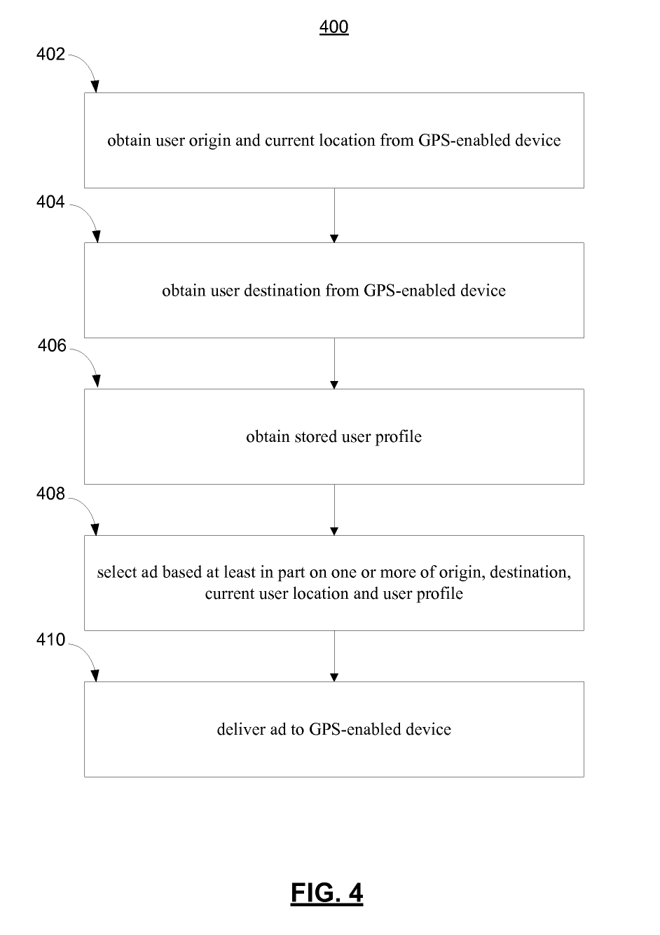

FIG. 4 is a flow diagram illustrating a method 400 according to one embodiment of the invention. At step 402, a user's origin and current location are obtained from the GPS-enabled device. At step 404, the user's destination location is obtained from the GPS-enabled device.

At step 406, the user's profile is obtained. The user profile may be a Yahoo! profile, or may be obtained or partially obtained from or using a third-party source, such as a social networking Web site or company. At step 408, an advertisement is generated or selected based at least in part on one or more of the origin location, destination location, current location, and user profile.

At step 410, the generated or selected advertisement is transmitted to the GPS-enabled device for presentation on the GPS device. In some embodiments, the advertisement may be transmitted wirelessly to the GPS device via a cellular data connection.

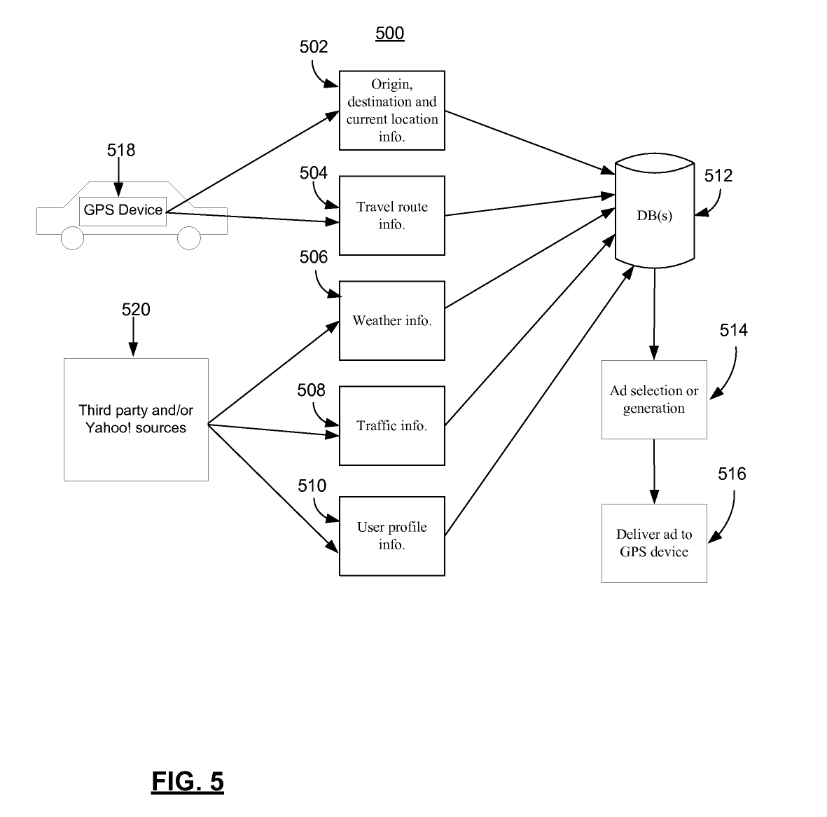

FIG. 5 is a block diagram 500 illustrating one embodiment of the invention. One or more data stores or databases 512 are depicted. Various types of information are stored in the database 512. In particular, types of depicted information stored in the database 512 include, potentially among many other types of information, origin, destination and current location information 502, travel route information 504, weather information 506, traffic information 508, and user profile information 510. The information stored in database 512 may be obtained, gathered, or generated in various ways from various sources. For example, origin, destination and current location information 502 and travel route information 504 may be obtained wirelessly from the user's GPS device via the Internet. Whereas weather information 506 and traffic information 508 may be obtained from third party sources 520 (e.g., www.weather.com) and/or from Yahoo! sources (e.g., weather.yahoo.com). Similarly, user profile information 510 may also be obtained from a third party source 520 (e.g., Facebook). Alternatively, or in addition, a user's existing Yahoo profile may be obtained.

Block 514 represents generation or selection of an online advertisement, targeted to a user of the GPS device. The advertisement may be generated or selected based at least in part on one or more of obtained information 502-510. In some embodiments, a previously generated advertisement may be provided by one or more advertiser computers and stored in database 512. The advertisement may be selected based at least in part on rules or criteria (specified by the advertiser) related to one or more of obtained information 502-510.

Block 516 represents delivery of the selected or generated advertisement to GPS device 518. The advertisement may be transmitted wirelessly over, for example, a cellular data connection. The advertisement may be presented directly on GPS device 518. Alternatively, in some embodiments, the advertisement may be played on the vehicle's sound system or video entertainment system.

Some embodiments of the invention help provide advertisers with information and tools to allow them to better compete for user attention by utilizing and referencing topics of interest. Advertisers can benefit, for example, from, for a particular target audience of interest to the advertiser, information that allows timely and effective targeting. One particular target audience that may be of interest to advertisers is users who are traveling in vehicles. One way of targeting users who are traveling in vehicles is to transmit advertisements to GPS enabled devices. These GPS enabled devices may include in-vehicle navigation systems and portable devices such as smart phones, tablets, and internet connected mobile GPS navigation devices.

One or more server computers (e.g., server computers 104 in FIG. 1) and/or advertiser computers (e.g., advertiser computers 106 in FIG. 1) may receive information from a GPS device (e.g., GPS device 104 in FIG. 1). This information may include, for example, travel origin location, destination location, travel route between origin and destination location, real-time traffic information, history of user interaction with an advertisement (e.g., did the user “click” on the ad), user profile preference information (e.g., a username and password to obtain the user's profile from a third party website) and information obtained from sensors in the vehicle (e.g., gasoline level, oil level, tire pressure, etc.). Alternatively, or in addition, one or more server computers and/or advertiser computers may also obtain information from third-party sources. For example, real-time traffic information may be obtained from websites such as www.traffic.com or www.beatthetraffic.com. Similarly, real-time weather information and user profile information may also be obtained from third-party sources. For example, a user may provide log-in information for a website that provides an online to-do list (e.g., www.rememberthemilk.com), and the user's to-do list may be retrieved by one or more server computers and/or advertiser computers. In another example, local events, activities and points of interest information for the origin, destination and along the route may be obtained from sites such as Yahoo! Local.

The exemplary information described above may be used independently, or in combination, to determine one or more potential interests of users. The one or more potential interests may be used to select advertisements that may be of interest to users, and the advertisements may then be transmitted to users' GPS devices for presentation on the GPS devices. For example, if a user is driving from Los Angeles to Seattle, the user may input the origin and destination locations into a GPS navigation device. The GPS device may calculate a travel route for the user to follow. The origin, destination and/or the travel route may then be transmitted by the GPS device to one or more server computers and/or advertiser computers. Based on this received information, the one or more server computers and/or advertiser computers may obtain real-time weather information (e.g., from www.weather.com). If the weather information indicates that it will be raining at the user's estimated time of arrival in Seattle, the one or more server computers and/or advertiser computers may determine that an umbrella might be of interest to the user. Thus, an advertisement for an umbrella store located along the user's travel route may be selected and transmitted to the GPS device for presentation. In addition, advertisements relating to tourist attractions that are unaffected by rainy weather, such as museums (as opposed to outdoor theme parks) may be selected and transmitted to the GPS device. In another example, if there is heavy traffic a few miles ahead along the travel route, the user may be presented with an ad for a coffee shop, in case the user would like to take an early exit and relax over a cup of coffee instead of being stuck in traffic.

In some embodiments, user profile information may be retrieved from third-party websites to determine user interests. For example, a user may input his log-in information for an online to-do list (e.g., www.rememberthemilk.com) into the GPS device. The log-in information may be transmitted to one or more server computer and/or advertiser computers. The one or more server computer and/or advertiser computers may then retrieve the user's profile information (which may include e.g., a to-do list) and determine that the user was planning to stop by the grocery store on the commute home from work. Based on this information, an advertisement such as, for example, “Take a 3 min detour to get milk for only $2.59 a gallon at Grocery Mart” may be selected and transmitted to the GPS device.

In some embodiments, the one or more server computers and/or advertiser computer may store a history of the advertisements that were presented to the user on the GPS device. In addition, the one or more server computers and/or advertiser computers may also store whether the user interacted with the ad (e.g., did the user “click” on the ad), and the types of ads the user interacts with (e.g., the user usually “clicks” on food related ads). In some embodiments, advertisement effectiveness may also be determined (and stored in the user profile) based on GPS information which may be obtained from the GPS device. For example, in the milk advertisement described above, the one or more server computers and/or advertiser computers may determine if the user actually went to Grocery Mart by obtaining GPS information from the GPS device. This information may then be stored in the user profile.

In some embodiments, real-time vehicle information may be obtained using the vehicle sensors. For example, the sensors may provide information relating to gasoline level, oil level, tire pressure, etc. to the GPS device, which may transmit the information to the one or more server computers and/or advertiser computers. The real-time vehicle information may then be used, independently or in combination with other real-time travel information obtained from the GPS device to select an advertisement. For example, if the car is low on gas, an advertisement for a gas station at the next exit may be presented on the GPS device.

In some embodiments of the invention, any of various types or categories of ads may be selected and displayed. For example, in some embodiments, the following types of ads may be utilized, among others.

An Ad type A could include ads related to destination, and could include and involve the following.

Data needed: Destination information as, weather, activities, traffic.
Sample ad: Ad relating to products related to things to do (check out the star trek convention) and things to avoid or be prepared for (rain at destination, you need to make sure you have umbrella).

An Ad type B could include ads related to traffic location, and could include or involve the following.

Data needed: Sensor information or retrieved traffic information, which may be sent via satellite to GPS system.
Sample ad: Side track exit to take to have something interesting to do while traffic lessens (Go have a meal, a cup of coffee, etc.).

An Ad type C could include ads related to traffic traveling habits, and could include or involve the following.

Data needed: The GPS system will learn certain behavior trends and habits of the user and store these with the user profile.
Sample ad: Suggesting some detour reminders for users, for things to do.

An Ad type D could include ads related to traffic traveling choices, and could include or involve the following.

Data needed: User profile with interests and what they like (movies, games, music etc.).
Sample ad: Ad targeting may be associated with the user's interests.

An Ad type E could include ads related to car sensor data, and could include or involve the following.

Data needed: Car sensor information about the car (Gas, oil, tire pressure, etc.)
Sample ad: May depending on car condition, may include suggesting an exit for an incentive or coupon relating to that.

Of course, ads and targeting of various types may be mixed, combined, etc.

In some embodiments, any of various strategies, priorities or algorithms may be used in determining parameters such as the type of ad to display, timing for advertisement serving or display, etc. In some embodiments, if a small screen GPS device is involved, this may be taken into account in such algorithms.

In some embodiments, the following algorithm, or algorithm elements, may be utilized, with reference to the types of ad categories A-E above, or other categories. Show display Ad IF:

### ((Destination Far) AND (No Exit on Sight)) OR (Type of AD NOT TO E)

### ELSE Display (Audio Ad) OR (Textual Ad).

### Condition\Ad to Show—A-B-C-D-E—Priority:

### Destination Close By—Prioritize A ads.

### High Traffic Ahead—Prioritize B ads.

Habit is triggered—Prioritize C ads.
Profile match—Prioritize D ads.
Sensor of car indication—Prioritize E ads.

While the invention is described with reference to the above drawings, the drawings are intended to be illustrative, and the invention contemplates other embodiments within the spirit of the invention.

1. A method comprising:
using one or more computers, obtaining real-time travel information relating to a user's travel route;
using one or more computers, determining one or more potential interests of the user based at least in part on the travel information;
using one or more computers, selecting an advertisement based at least in part on at least one of the one or more potential interests; and
using one or more computers, transmitting the advertisement to a GPS device of the user for presentation on the GPS device.

2. The method of claim 1, wherein the real-time travel information comprises one or more of starting location, destination location, direction of travel, weather information, traffic information and user profile information.

3. The method of claim 1, further comprising:
using one or more computers, obtaining real-time vehicle information via one or more sensors in the vehicle; and
using one or more computers, determining one or more potential interests of the user based at least in part on the vehicle information.

4. The method of claim 3, wherein the real-time vehicle information comprises one or more of gasoline level, oil level, coolant level, windshield wiper fluid level and tire pressure.

5. The method of claim 1, wherein the advertisement comprises at least one of textual, graphical, audio and video data.

6. The method of claim 1, wherein the GPS device is a mobile communications device with navigation software.

7. The method of claim 1, wherein the GPS device is a stand-alone portable navigation device.

8. The method of claim 1, wherein the GPS device is a built-in navigation device in the vehicle.

9. A system comprising:
one or more server computers coupled to a network; and
one or more databases coupled to the one or more server computers;
wherein the one or more server computers are for:
obtaining real-time travel information relating to a user's travel route;
determining one or more potential interests of the user based at least in part on the travel information;
selecting an advertisement based at least in part on at least one of the one or more potential interests; and
transmitting the advertisement to a GPS device of the user for presentation on the GPS device.

10. The system of claim 9, wherein the real-time travel information comprises one or more of starting location, destination location, direction of travel, weather information, traffic information and user profile information.

11. The system of claim 9, wherein the one or more server computers are for:
obtaining real-time vehicle information via one or more sensors in the vehicle; and
determining one or more potential interests of the user based at least in part on the vehicle information.

12. The system of claim 11, wherein the real-time vehicle information comprises one or more of gasoline level, oil level, coolant level, windshield wiper fluid level and tire pressure.

13. The system of claim 9, wherein the advertisement comprises at least one of textual, graphical, audio and video data.

14. The system of claim 9, wherein the GPS device is a mobile communications device with navigation software.

15. The system of claim 9, wherein the GPS device is a stand-alone portable navigation device.

16. The system of claim 9, wherein the GPS device is a built-in navigation device in the vehicle.

17. The system of claim 9, wherein at least one of the one or more server computers are coupled to the internet.

18. The system of claim 9, comprising storing the real-time travel information in at least one of the one or more databases.

19. The system of claim 9, comprising storing the advertisement in at least one of the one or more databases.

20. A computer readable medium or media containing instructions for executing a method comprising:
using one or more computers, obtaining real-time travel information relating to a user's travel route;
using one or more computers, obtaining real-time vehicle information via one or more sensors in the vehicle; and
using one or more computers, determining one or more potential interests of the user based at least in part on the travel information and the vehicle information;
using one or more computers, selecting an advertisement based at least in part on at least one of the one or more potential interests; and
using one or more computers, transmitting the advertisement to a GPS device of the user for presentation on the GPS device.
